(19) United States
(12) Patent Application Publication
(10) Pub. No.: US 2015/0037779 A1
(43) Pub. Date: Feb. 5, 2015

(54) DISCUSSION SUPPORT APPARATUS AND DISCUSSION SUPPORT METHOD

(71) Applicant: FUJITSU LIMITED, Kawasaki-shi (JP)

(72) Inventors: Takeaki Kobayashi, Yokohama (JP); Hidehiko Mayumi, Kawasaki (JP); Toshio Tanaka, Yokohama (JP); Masahiro Kawasaki, Kawasaki (JP)

(21) Appl. No.: 14/300,314

(22) Filed: Jun. 10, 2014

(30) Foreign Application Priority Data
Jul. 30, 2013 (JP) 2013-157881

(51) Int. Cl. G09B 5/10

(52) U.S. Cl. CPC G09B 5/10
USPC 434/350

(57) ABSTRACT

A non-transitory computer-readable recording medium has a program stored therein for causing a computer to execute a discussion support method, and the method includes calculating a correlation between an opinion of a student and a plurality of agendas for each opinion of the student; forming one or more groups of the students associated with one or more of the agendas, respectively, based on the correlations of the opinions and the agendas; and transmitting the one or more of the agendas to terminals of the students in the respective groups associated with the respective agendas.

### CROSS-REFERENCE TO RELATED APPLICATIONS

This application is based upon and claims the benefit of priority of the prior Japanese Priority Application No. 2013-157881 filed on Jul. 30, 2013, the entire contents of which are hereby incorporated by reference.

### FIELD

The disclosures herein generally relate to a discussion support program, a discussion support apparatus and a discussion support method.

### BACKGROUND

In recent years, education using electronic terminals such as tablet terminals has become popular. As an aspect of the education using electronic terminals, electronic terminals are used for making a discussion by a group of students.

As an aspect of the discussion using electronic terminals, a teacher gives a problem to students to have the students input their opinions about the problem into the electronic terminals. Then, the teacher displays the opinions of the students on a screen to have a discussion.

### RELATED-ART DOCUMENTS

### Patent Documents

[Patent Document 1] Japanese Laid-open Patent Publication No. 2009-8729

In the aspect described above, there are cases where the teacher selects an appropriate agenda based on the displayed opinions, and selects students having related opinions with each other to make them discuss the agenda deeply.

However, the teacher needs a long time to summarize related opinions of the students to give an appropriate agenda.

### SUMMARY

According to an at least one embodiment of the present invention, a non-transitory computer-readable recording medium has a program stored therein for causing a computer to execute a discussion support method, and the method includes calculating a correlation between an opinion of a student and a plurality of agendas for each opinion of the student; forming one or more groups of the students associated with one or more of the agendas, respectively, based on the correlations of the opinions and the agendas; and transmitting the one or more of the agendas to terminals of the students in the respective groups associated with the respective agendas.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating an example of a configuration of a discussion support system;

FIG. 2 is a schematic view illustrating an example of a hardware configuration of a teacher terminal;

FIG. 3 is a schematic view illustrating an example of a student DB;

FIG. 4 is a schematic view illustrating an example of a problem DB;

FIG. 5 is a schematic view illustrating an example of an opinion DB;

FIG. 6 is a schematic view illustrating an example of an agenda table;

FIG. 7 is a schematic view illustrating an example of a synonym DB;

FIG. 8 is a schematic view illustrating an example of a consensus work table;

FIG. 9 is a schematic view illustrating an example of a discussion DB;

FIG. 10 is a schematic view illustrating an example of a representative opinion work table;

FIG. 11 is a schematic view illustrating functions of a teacher terminal;

FIG. 12 is a flowchart illustrating operations of a teacher terminal;

FIG. 13 is a flowchart illustrating a process of consensus calculation;

FIG. 14 is a schematic view illustrating an example of a problem selection screen displayed on a teacher terminal;

FIG. 15 is a schematic view illustrating an example of a problem screen displayed on a student terminal;

FIG. 16 is a schematic view illustrating an example of an opinion display screen displayed on a teacher terminal;

FIG. 17 is a first schematic view illustrating an example of an opinion display screen displayed on a teacher terminal after grouping;

FIG. 18 is a schematic view illustrating a first example of a discussion screen displayed on a student terminal;

FIG. 19 is a schematic view illustrating a second example of a discussion screen displayed on a student terminal;

FIG. 20 is a second schematic view illustrating an example of an opinion display screen displayed on a teacher terminal after grouping;

FIG. 21 is a third schematic view illustrating an example of an opinion display screen displayed on a teacher terminal after grouping; and

FIG. 22 is a schematic view illustrating an example of a discussion result display screen displayed on a teacher terminal.

### DESCRIPTION OF EMBODIMENTS

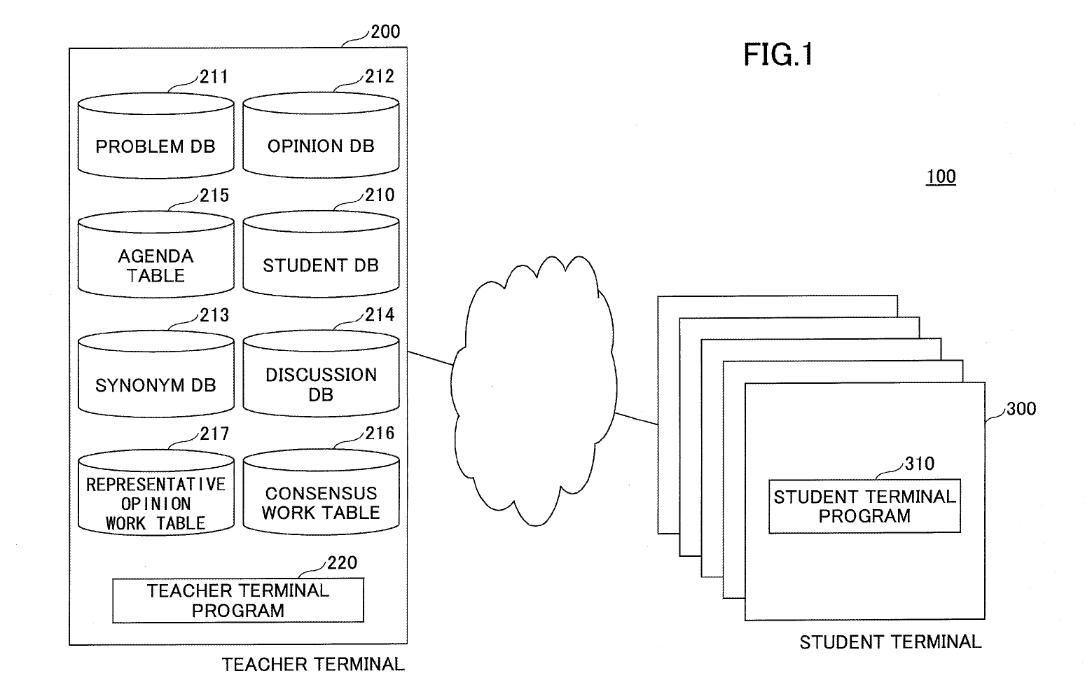

In the following, embodiments of the present invention will be described with reference to the drawings. FIG. 1 is a schematic view illustrating an example of a configuration of a discussion support system 100 in the present embodiment.

The discussion support system 100 includes a discussion support server 200 and multiple electronic terminals 300. The discussion support server 200 and the multiple electronic terminals 300 are connected with each other via a network.

In the discussion support system 100, for example, each student inputs an opinion about a given problem on the electronic terminal 300, and students having related opinions are grouped together to have discussions on agendas given to the groups.

When the discussion support system 100 is used in a class, the discussion support server 200 is used as a terminal for a teacher, and the electronic terminals 300 are used as terminals for students. Therefore, the discussion support server 200 is called the “teacher terminal 200, and the electronic terminals 300 are called the “student terminals” 300 in the following description.

The teacher terminal 200 and the student terminals 300 may be tablet terminals. Alternatively, the teacher terminal 200 may be, for example, a desktop or notebook computer, and the student terminals 300 may be tablet terminals.

The teacher terminal 200 includes a student DB 210, a problem DB 211, an opinion DB 212, a synonym DB 213, and a discussion DB 214. The teacher terminal 200 also includes an agenda table 215, a consensus work table 216, and a representative opinion work table 217. The teacher terminal 200 also has a teacher terminal program 220 installed. The teacher terminal program 220 includes a discussion support program.

Also, the student terminal 300 has a student terminal program 310 installed. The student terminal program 310 is a program to have the student terminal 300 execute a process, which will be described later, in the discussion support system 100.

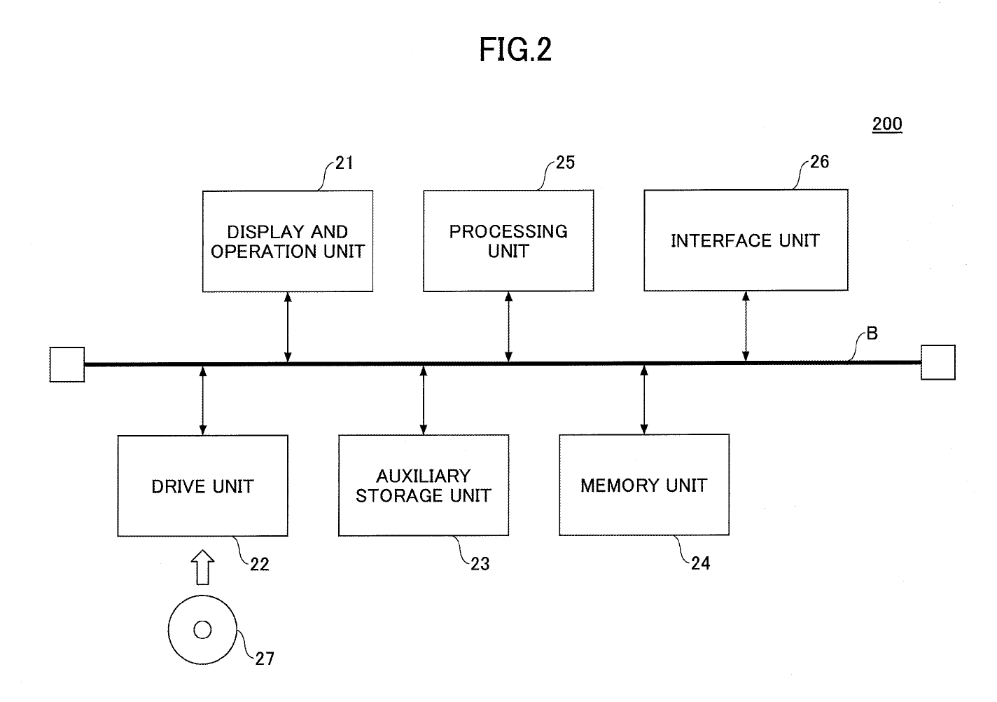

FIG. 2 is a schematic view illustrating an example of a hardware configuration of the teacher terminal 200 in the present embodiment. The teacher terminal 200 includes a display and operation unit 21, a drive unit 22, an auxiliary storage unit 23, a memory unit 24, a processing unit 25, and an interface unit 26, which are mutually connected by a bus B.

The display and operation unit 21 may be a touch panel, which is used for inputting various signals and displaying various information.

The interface unit 26 includes a modem and a LAN (Local Area Network) card that are used for connecting with a network.

The teacher terminal program 220 is at least a part of various programs that control the teacher terminal 200. The teacher terminal program 220 is provided, for example, by distributing a recording medium 27, or by downloading from a network. As the recording medium 27 that records the teacher terminal program 220, various types of recording media can be used including recording media that record information optically, electrically or magnetically such as a CD-ROM, a flexible disk, and an optical magnetic disk, and semiconductor memories that record information electrically such as a ROM and a flash memory.

Also, when the recording medium 27 that stores the teacher terminal program 220 is set in the drive unit 22, the teacher terminal program 220 is installed on the auxiliary storage unit 23 via the drive unit 22 from the recording medium 27. The teacher terminal program 220 downloaded from a network is installed on the auxiliary storage unit 23 via the interface unit 26.

The auxiliary storage unit 23 stores the installed teacher terminal program 220, and also stores required files, data, and the like. The memory unit 24 reads and stores the teacher terminal program 220 from the auxiliary storage unit 23 when activating a computer. And the processing unit 25 implements various processes, which will be described later, following the teacher terminal program 220 stored in the memory unit 24.

Note that the teacher terminal 200 may be, for example, a desktop or notebook computer in the present embodiment. In this case, the teacher terminal 200 includes an input unit including a keyboard and a mouse, and an output unit including a display, instead of the display and operation unit 21.

The hardware configuration of the student terminal 300 is the same as that of the teacher terminal 200, and its description is omitted.

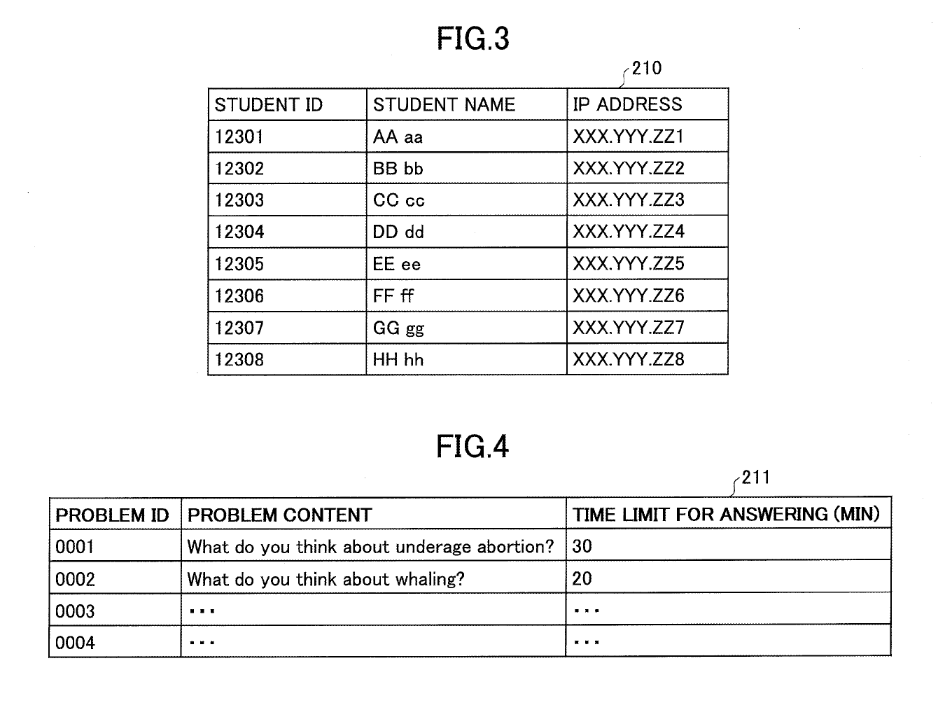

In the following, DBs and tables stored in the teacher terminal 200 will be described with reference to FIGS. 3-10. The DBs and tables are stored, for example, in predetermined storage areas of the auxiliary storage unit 23 or the memory unit 24 in the teacher terminal 200.

FIG. 3 is a schematic view illustrating an example of the student DB 210. The student DB 210 is registered beforehand, for example, by a teacher who operates the teacher terminal 200. The student DB 210 stores the IP address of a student terminal 300 associated with a student identifier (student ID) and a student name for each of the student terminals 300. The IP address is information that identifies a student terminal 300.

FIG. 4 is a schematic view illustrating an example of the problem DB 211. The problem DB 211 is registered beforehand, for example, by a teacher who operates the teacher terminal 200. In the problem DB 211, a problem ID is associated with problem content, and a time limit for answering each problem.

A problem selected in the problem DB 211 on the teacher terminal 200 is transmitted to the student terminals 300. Note that a problem in the present embodiment is, for example, text data representing problem content.

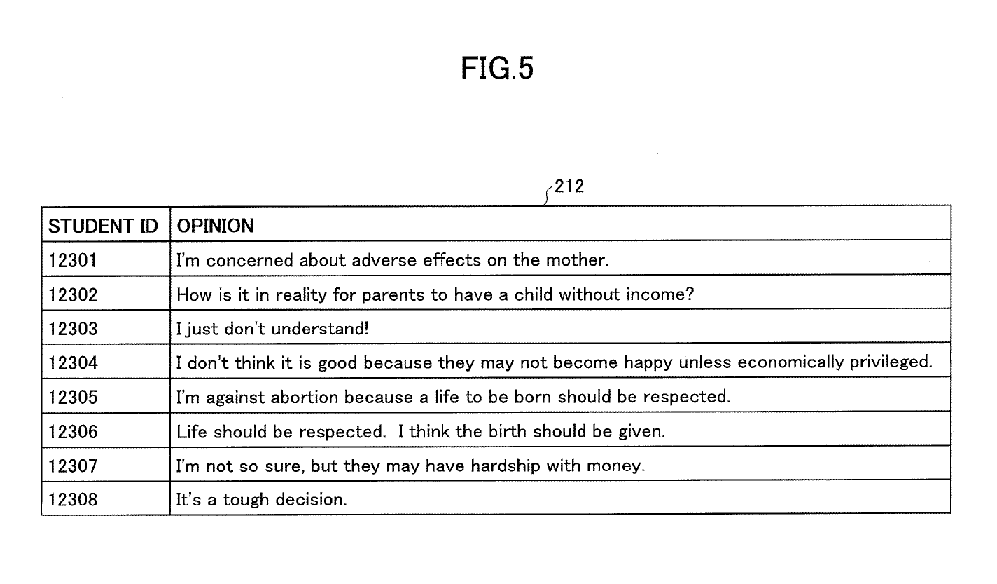

FIG. 5 is a schematic view illustrating an example of the opinion DB.

The opinion DB 212 is a database generated for each problem ID, and an example in FIG. 5 is the opinion DB 212 that corresponds to problem ID 0001. In the opinion DB 212, an opinion about a problem input by a student on a student terminal 300 is associated and stored with the student ID of the student who inputs the opinion. Note that an opinion in the present embodiment is, for example, text data representing the content of an opinion.

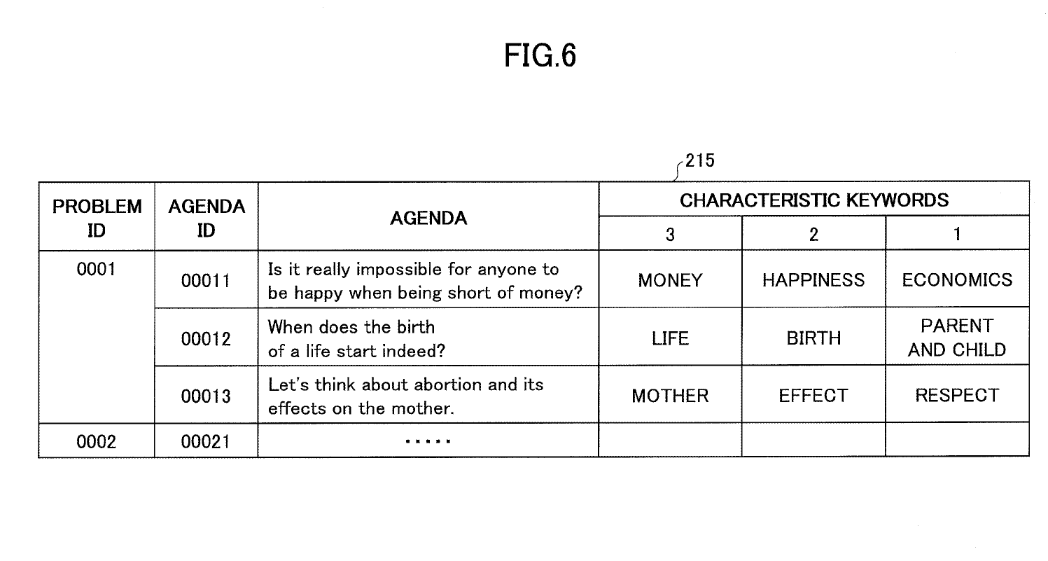

FIG. 6 is a schematic view illustrating an example of the agenda table 215. The agenda table 215 is registered beforehand, for example, by a teacher who operates the teacher terminal 200. The agenda table 215 stores agendas given to groups after grouping of students has been done by a method as will be described later. Note that an agenda is text data that represents the content of an agenda.

In the agenda table 215, a problem ID is associated with agenda IDs, agendas, and characteristic keywords. Note that an agenda is text data that represents the content of an agenda. Each agenda ID is associated with multiple characteristic keywords. A characteristic keyword is a keyword that relates to the content of an agenda, which is set beforehand in accordance with the agenda.

In the example in FIG. 6, three agendas, or agenda IDs 00011, 00012, and 00013 are provided for problem ID 0001, and three characteristic keywords are set for each of the agendas.

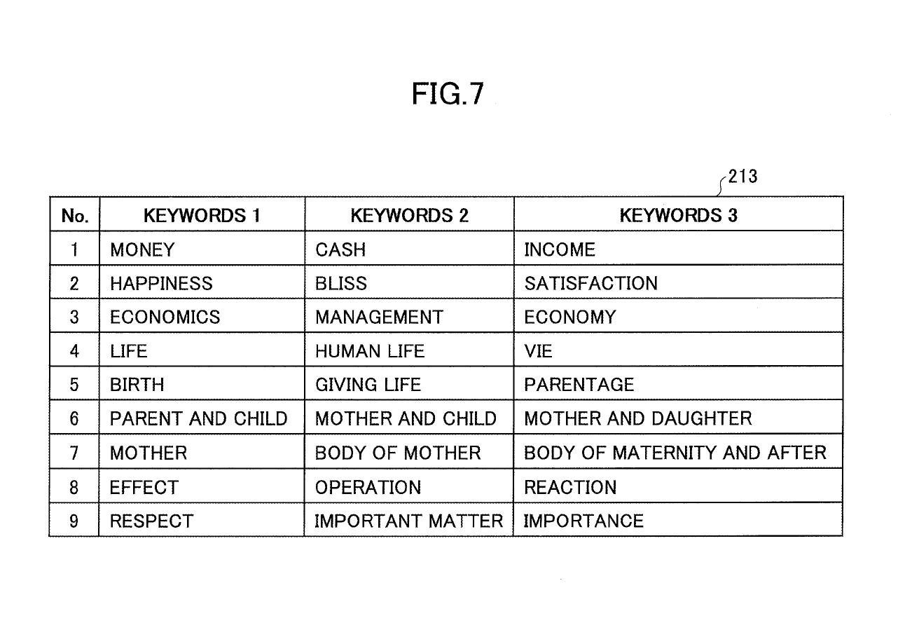

FIG. 7 is a schematic view illustrating an example of a synonym DB. The synonym DB 213 is a database of words where a word is associated with another word that has a different form, but has a similar meaning, which may be alternatively used. The synonym DB 210 may be registered beforehand, for example, by a teacher who operates the teacher terminal 200.

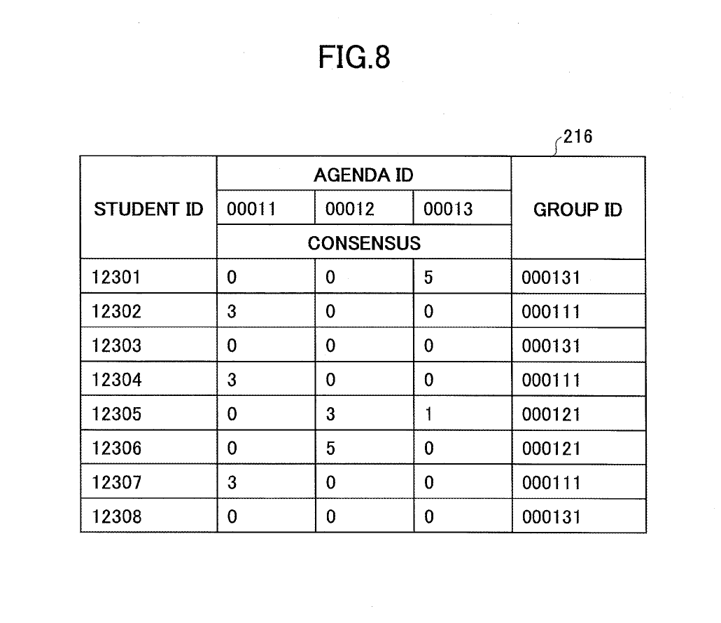

FIG. 8 is a schematic view illustrating an example of the consensus work table 216. The consensus work table 216 is used for grouping students based on opinions of the students about a problem. In the consensus work table 216, a student ID is associated with degrees of consensus between agendas and the opinion of the student about the agendas, and a group ID that identifies the group of the student. The consensus work table 216 will be described in detail later.

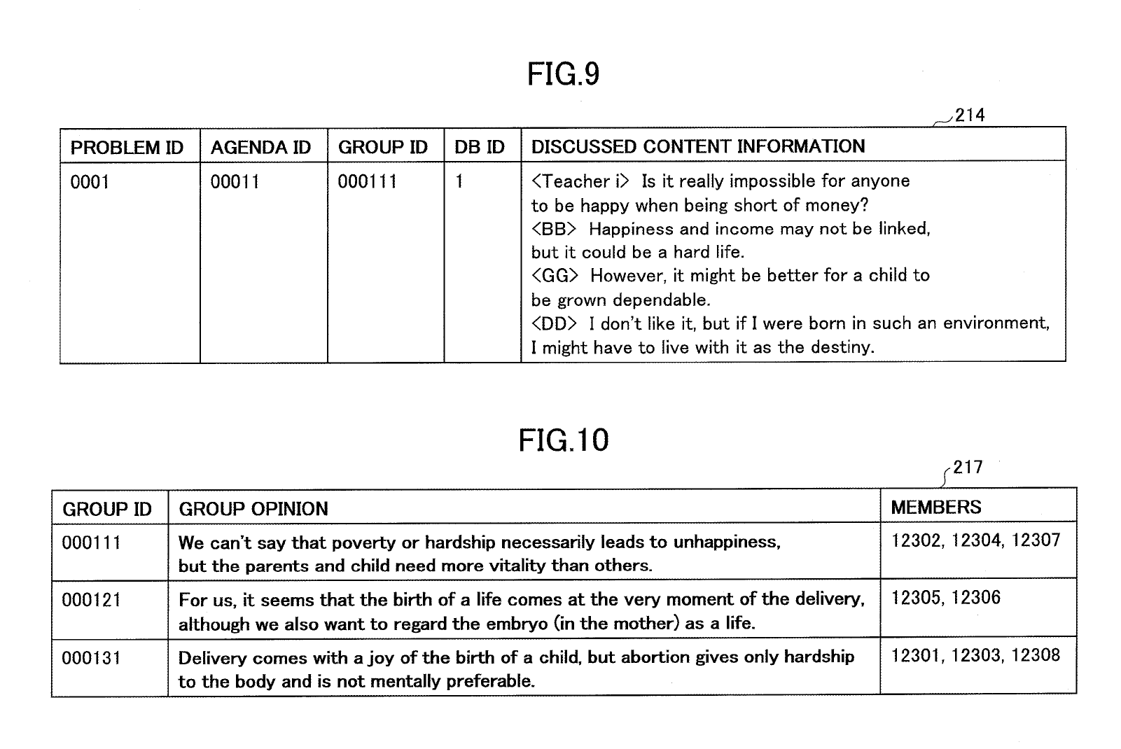

FIG. 9 is a schematic view illustrating an example of the discussion DB 214. The discussion DB 214 is a database that is generated for each group after grouping has been done for the students, and an agenda has been assigned to each of the groups.

In the discussion DB 214, a problem ID is associated with an agenda ID, a group ID, a database identification information (DB ID), and the content of the discussion information. The content of the discussion information is text data that represents the contents of opinions of students in the same group, which have been input on the student terminals 300. The student terminals 300 in the same group can refer to the contents of the discussion information in the discussion DB 214.

FIG. 10 is a schematic view illustrating an example of the representative opinion work table 217. In the representative opinion work table 217, a group ID is associated with a group opinion (representative opinion) and members of the group.

In the representative opinion work table 217, a representative opinion of a group is stored that is obtained as a result of a discussion. Also, members of a group are represented by student IDs.

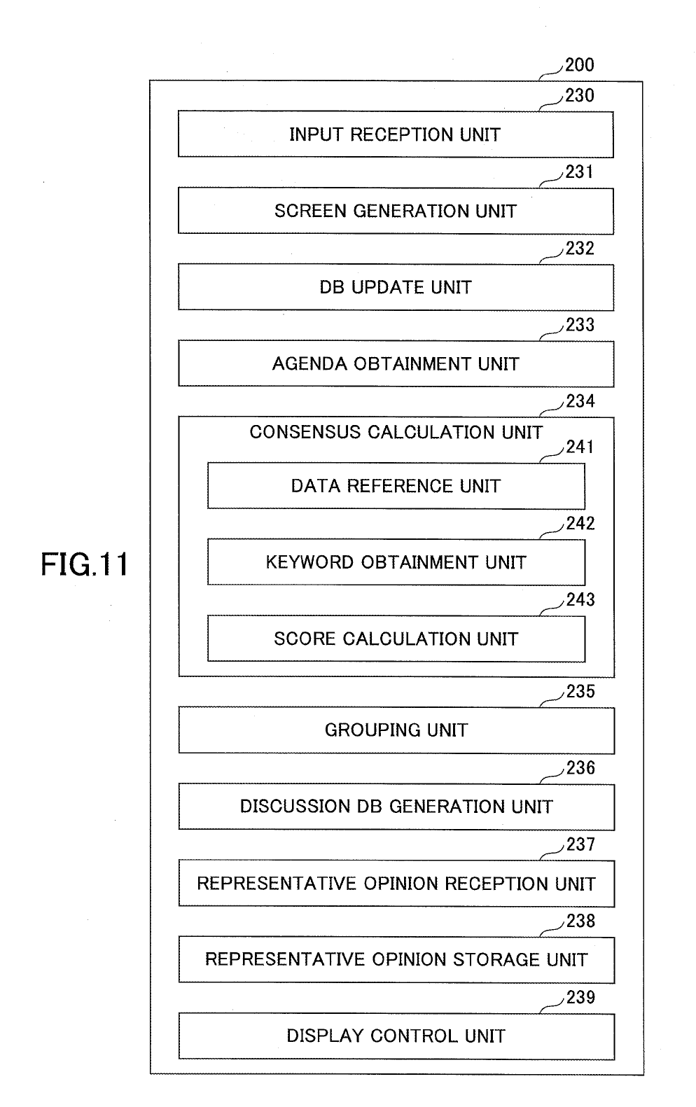

Next, functions of the teacher terminal 200 will be described according to the present embodiment with reference to FIG. 11. A process executed by each unit described below is implemented by executing the teacher terminal program 220. FIG. 11 is a schematic view illustrating functions of the teacher terminal 200.

The teacher terminal 200 includes an input reception unit 230, a screen generation unit 231, a DB update unit 232, an agenda obtainment unit 233, a consensus calculation unit 234, and a grouping unit 235. The teacher terminal 200 also includes a discussion DB generation unit 236, a representative opinion reception unit 237, a representative opinion storage unit 238, and a display control unit 239.

The input reception unit 230 receives input of information on the teacher terminal 200. The screen generation unit 231 generates screen data to be displayed on the display and operation unit 21 of the student terminal 300. The DB update unit 232 updates each of the databases when a process proceeds.

The agenda obtainment unit 233 obtains an agenda that is associated with a problem from the agenda table 215. The consensus calculation unit 234 calculates consensus between an agenda obtained by the agenda obtainment unit 233 and an opinion of a student as a value that represents a correlation between the agenda obtained by the agenda obtainment unit 233 and the opinion of the student. The consensus calculation unit 234 will be described in detail later. The grouping unit 235 executes grouping by associating a student with agenda information, based on the correlation between the agenda obtained by the agenda obtainment unit 233 and the opinion of the student. Specifically, the grouping unit 235 executes grouping by associating a student with an agenda, based on the consensus calculated as the value representing the correlation. The grouping unit 235 executes grouping by assigning a group ID to a student ID.

The discussion DB generation unit 236 generates the discussion DB 214 for each group formed after the grouping. The discussion DB generation unit 236 generates the discussion DB 214 for each group, for example, in a predetermined storage area of the auxiliary storage unit 23 or the memory unit 24.

The representative opinion reception unit 237 receives representative opinions from the groups that are transmitted from the student terminals 300. The representative opinion storage unit 238 stores the representative opinions of the groups in the representative opinion work table 217. The display control unit 239 controls displaying on the display and operation unit 21.

In the following, the consensus calculation unit 234 will be further described. The consensus calculation unit 234 includes a data reference unit 241, a keyword obtainment unit 242, and a score calculation unit 243.

The data reference unit 241 refers to the databases and the tables used by a consensus calculation process. The keyword obtainment unit 242 obtains, for example, characteristic keywords stored in the agenda table 215 and synonyms stored in the synonym DB 213. The score calculation unit 243 calculates a score that represents consensus between an agenda and the opinion of a student using the keywords obtained by the keyword obtainment unit 242.

The process of the consensus calculation unit 234 will be described in detail later.

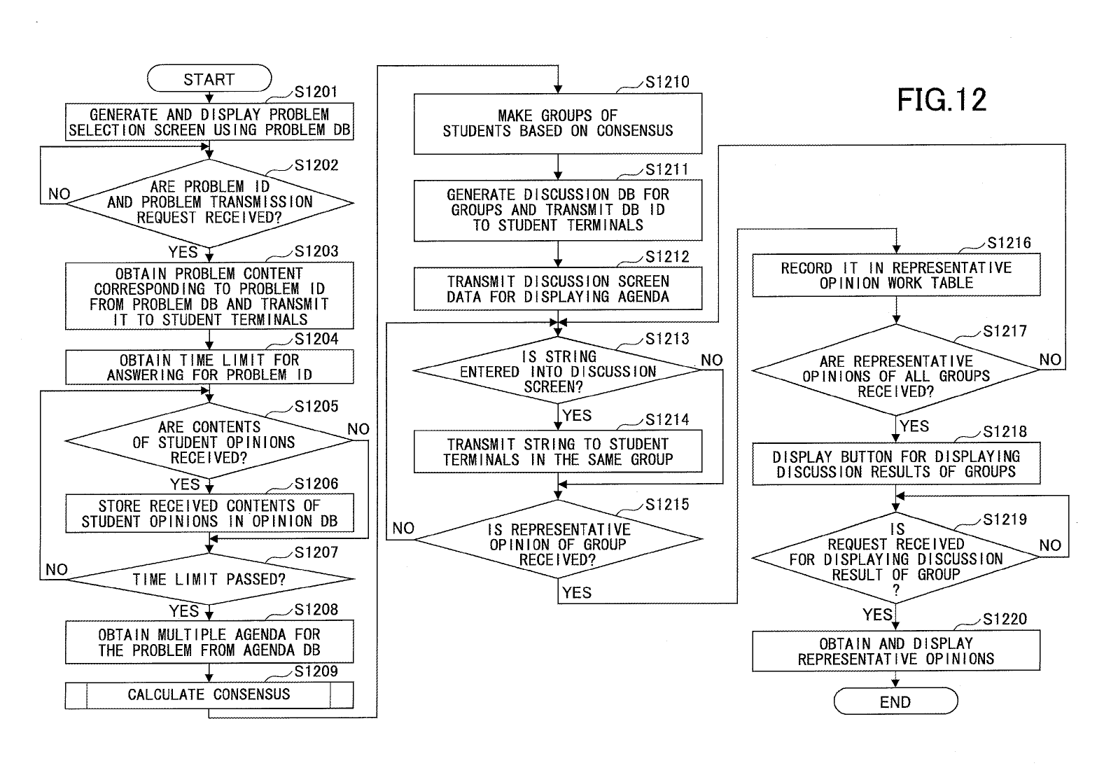

Next, operations of the teacher terminal 200 will be described according to the present embodiment with reference to FIG. 12. FIG. 12 is a flowchart illustrating operations of the teacher terminal 200.

In the teacher terminal 200, the display control unit 239 refers to the problem DB 211 to generate a problem selection screen, and has the display and operation unit 21 display the screen (Step S1201). Next, the teacher terminal 200 determines whether the input reception unit 230 has received a problem ID and a transmission request for a problem (Step S1202). At Step S1202, if a problem ID and a transmission request have not been received, the teacher terminal 200 waits for a reception of a problem ID and a transmission request.

At Step S1202, in response to receiving a problem ID and a transmission request, the screen generation unit 231 obtains the problem content that corresponds to the problem ID received from the problem DB 211, generates problem screen data, and transmits the problem screen data to all the student terminals 300 (Step S1203). Next, the teacher terminal 200 obtains a time limit for answering that corresponds to the problem ID received from the problem DB 211 (Step S1204).

Next, the teacher terminal 200 determines whether the input reception unit 230 receives the content of an opinion about the problem from a student terminal 300 (Step S1205). At Step S1205, if not having received the content of an opinion, the teacher terminal 200 goes forward to Step S1207, which will be described later.

At Step S1205, if having received the content of an opinion, the teacher terminal 200 stores the received content of the opinion in the opinion DB 212 by the DB update unit 232 (Step S1206). Note that the content of an opinion is text data input at a student terminal 300. Next, the teacher terminal 200 determines whether the time limit for answering obtained at Step S1204 has passed (Step S1207).

At Step S1207, if the time limit for answering has not passed, the teacher terminal 200 goes back to Step S1205.

At Step S1207, if the time limit for answering has passed, the agenda obtainment unit 233 refers to the agenda table 215, and obtains agendas corresponding to the received problem ID (Step S1208). Specifically, the agenda obtainment unit 233 obtains multiple agendas associated with the problem ID in the agenda table 215.

Next, the teacher terminal 200 has the consensus calculation unit 234 calculate consensus between the obtained agendas and the contents of opinions stored in the opinion DB 212 (Step S1209). Specifically, the consensus calculation unit 234 calculates consensus between the multiple agendas and the contents of the opinions for each student. Next, the teacher terminal 200 executes grouping of student IDs based on the consensus obtained by the grouping unit 235 (Step S1210). Specifically, the grouping unit 235 forms a group of student IDs that have the highest consensus for the same agenda. Note that the capacity size limit of a group is set by a teacher beforehand in the present embodiment. The calculation of consensus and the grouping process will be described in detail later.

Next, the teacher terminal 200 has the discussion DB generation unit 236 generate the discussion DB 214 for each of the formed groups, and transmits a DB ID associated with the group ID to student terminals 300 in the same group (Step S1211).

Next, the teacher terminal 200 has the screen generation unit 231 generate discussion screen data in which the agenda associated with the group of the student terminals 300 and the opinions of the students in the same group are displayed, and transmits it to the student terminals 300. (Step S1212). In the present embodiment, when the discussion screen is displayed on the student terminal 300, the student terminal 300 accesses the discussion DB 214 associated with the group ID allocated to itself.

Next, the teacher terminal 200 determines whether a string is input on the discussion screen on the student terminal 300 (Step S1213). At Step S1213, if a string is not input, the teacher terminal 200 goes forward to Step S1215, which will be described later.

At Step S1213, if a string is input, the teacher terminal 200 stores the input string in the associated discussion DB 214, and transmits the input string to the student terminals 300 in the same group that access the discussion DB 214. (Step S1214).

Next, the teacher terminal 200 determines whether the representative opinion reception unit 237 has received a representative opinion from one of the groups (Step S1215). At Step S1215, if not receiving a representative opinion, the teacher terminal 200 goes back to Step S1213.

At Step S1215, if receiving a representative opinion, the representative opinion storage unit 238 stores the received representative opinion in the representative opinion work table 217 (Step S1216). Next, the teacher terminal 200 determines whether representative opinions of all groups have been received (Step S1217). At Step S1217, if representative opinions of all groups have not been received, the teacher terminal 200 goes back to Step S1213.

At Step S1217, if representative opinions of all groups have been received, the display control unit 239 has the display and operation unit 21 display a discussion result display button for displaying a result of a discussion of the groups (Step S1218). Next, the teacher terminal 200 determines whether a request for displaying the discussion result is received at the input reception unit 230 (Step S1219). Specifically, the teacher terminal 200 determines whether the discussion result display button is operated (pushed or touched).

At Step S1219, if a request for displaying the discussion result is not received, the teacher terminal 200 waits for a reception of a request for displaying the discussion result. At Step S1219, if a request for displaying the discussion result is received, the display control unit 239 obtains representative opinions of the groups from the representative opinion work table 217, and displays them on the display and operation unit 21 (Step S1220).

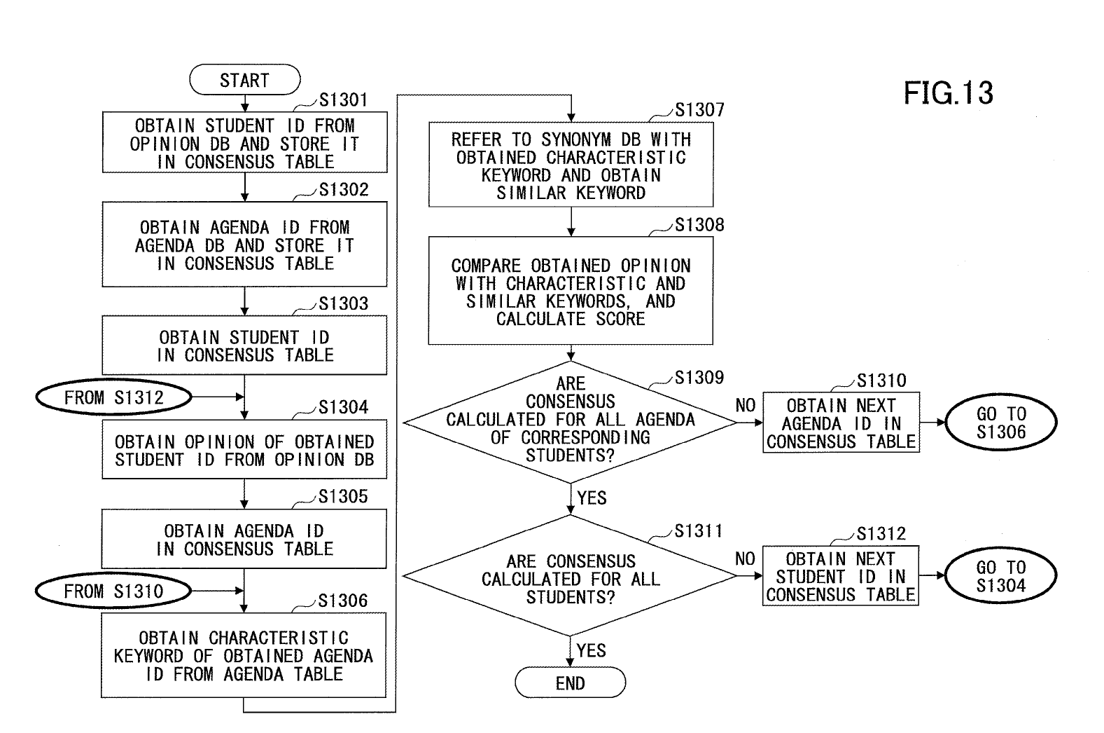

Next, a consensus calculation process will be described with reference to FIG. 13 that is executed by the consensus calculation unit 234 at Step S1209 in FIG. 12. FIG. 13 is a flowchart illustrating the process of consensus calculation.

Following Step S1208 in FIG. 12, the teacher terminal 200 has the data reference unit 241 of the consensus calculation unit 234 refer to the opinion DB 212 to obtain student IDs for storing them in the consensus work table 216 (Step S1301).

Next, the data reference unit 241 refers to the agenda table 215 to obtain agenda IDs of respective agendas obtained at Step S1208, and stores them in the consensus work table 216 (Step S1302).

Next, the data reference unit 241 obtains a student ID stored in the consensus work table 216 (Step S1303), and obtains opinions associated with the obtained student ID from the opinion DB 212 (Step S1304). Note that a student ID stored first in the consensus work table 216 may be obtained at Step S1303.

Next, the data reference unit 241 obtains an agenda ID stored in the consensus work table 216 (Step S1305). The data reference unit 241 may obtain an agenda ID stored first in the consensus work table 216. Next, the keyword obtainment unit 242 refers to the obtained agenda table 215 to obtain characteristic keywords associated with the obtained agenda ID (Step S1306).

Moreover, the keyword obtainment unit 242 refers to the synonym DB 213 to obtain synonyms of the obtained characteristic keywords from the synonym DB 213 (Step S1307). In the following description, synonyms obtained from the synonym DB 213 by the keyword obtainment unit 242 are called similar keywords.

Next, the score calculation unit 243 determines whether an obtained opinion includes a word equivalent to one of the characteristic keywords and similar keywords obtained from the agenda ID, and based on the determination result, calculates a consensus between the opinion and the agenda associated with the agenda ID, as a score (Step S1308). Step S1308 will be described in detail later.

Next, the consensus calculation unit 234 determines whether the consensus has been calculated for every opinion of the student obtained at Step S1301 and every agenda (Step S1309). At Step S1309, if the consensus has not been calculated for every agenda, the consensus calculation unit 234 obtains a next agenda ID from the consensus work table 216 (Step S1310), and goes back to Step S1306.

At Step S1309, if the consensus has been calculated for every agenda, the consensus calculation unit 234 determines whether the consensus has been calculated for every student (Step S1311). At Step S1311, if the consensus has not been calculated for every student, the consensus calculation unit 234 obtains a next student ID from the consensus work table 216 (Step S1312), and goes back to Step S1304.

At Step S1311, if the consensus has been calculated for every student, the teacher terminal 200 ends the consensus calculation process, and goes forward to Step S1210 in FIG. 12.

In the following, the consensus calculation process will be concretely described according to the present embodiment with reference to FIGS. 6-8. In the following description, an example is illustrated where a problem having problem ID 0001 is selected on the teacher terminal 200.

First, in the consensus calculation unit 234, the data reference unit 241 obtains student IDs of all students from the opinion DB 212, and stores them in fields for the student ID in the consensus work table 216. The student IDs stored in the opinion DB 212 illustrated in FIG. 5 are 12301 to 12308. Therefore, the data reference unit 241 stores student IDs 12301-12308 in the fields for the student ID in the consensus work table 216 (see FIG. 8).

Next, the data reference unit 241 obtains agenda IDs from the agenda table 215. The data reference unit 241 obtains agenda IDs associated with problem ID 0001. In the agenda table 215 illustrated in FIG. 6, the agenda IDs associated with problem ID 0001 are 00011, 00012, and 00013. Therefore, the data reference unit 241 obtains agenda IDs 00011, 00012, and 00013 as illustrated in FIG. 8, and stores them in the fields for the agenda ID in the consensus work table 216.

Next, the data reference unit 241 obtains student ID 12301 as the student ID stored first in the consensus work table 216, and obtains an opinion associated with student ID 12301 from the opinion DB 212.

Next, the data reference unit 241 obtains agenda ID 00011 as the agenda ID stored first in the consensus work table 216, and obtains characteristic keywords associated with agenda ID 00011 from the agenda table 215.

The characteristic keywords associated with agenda ID 00011 are “money”, “happiness”, and “economics”. Note that points are assigned beforehand to characteristic keywords that are used in a process executed by the score calculation unit 243, which will be described later. For example, “money” is assigned three points, “happiness” is assigned two points, and “economics” is assigned one point.

Next, the keyword obtainment unit 242 obtains similar keywords of the three keywords from the synonym DB 213. For example, similar keywords of “money” are “cash” and “income”, and similar keywords of “happiness” are “bliss” and “satisfaction” (see FIG. 7).

Next, the score calculation unit 243 calculates a consensus between an agenda and an opinion of a student. First, the score calculation unit 243 obtains the opinion of student ID 12301 stored in the consensus work table 216, from the opinion DB 212. Then, the score calculation unit 243 determines whether a word equivalent to the characteristic keyword “money” or one of the similar keywords of “money” exists in the obtained opinion.

The opinion of student ID 12301 is “I'm concerned about adverse effects on the mother” (see FIG. 5). Therefore, a word equivalent to the characteristic keyword “money” or one of the similar keywords of “money” does not exist in the opinion of student ID 12301. Similarly, a word equivalent to the characteristic keyword “happiness”, which is associated with agenda ID 00011, or one of the similar keywords of “happiness” does not exist in the opinion of student ID 12301. It is the same for the characteristic keyword “economics”, which is associated with agenda ID 00011, or one of the similar keywords of “economics”.

Therefore, the score of the consensus between the opinion of student ID 12301 and agenda ID 00011 is zero point.

Next, the consensus calculation unit 234 obtains a characteristic keyword associated with agenda ID 00012 from the agenda table 215.

The characteristic keywords associated with agenda ID 00012 are “life”, “birth”, and “parent and child”. Here, “life” is assigned three points, “birth” is assigned two points, and “parent and child” is assigned one point.

Next, the keyword obtainment unit 242 obtains similar keywords of the three keywords from the synonym DB 213. For example, similar keywords of “life” are “human life” and “la vie”, and similar keywords of “birth” are “giving life” and “parentage” (see FIG. 7).

Next, the score calculation unit 243 determines whether a word equivalent to the characteristic keyword “life” or one of the similar keywords of “life” exists in the obtained opinion. A corresponding word does not exist in the opinion of student ID 12301.

The score calculation unit 243 executes similar determinations for the characteristic keyword “birth” and its similar keywords, and for the characteristic keyword “parent and child” and its similar keywords. A corresponding word does not exist in the opinion of student ID 12301.

Next, the consensus calculation unit 234 obtains a characteristic keyword associated with agenda ID 00013 from the agenda table 215.

The characteristic keywords associated with agenda ID 00013 are “the mother”, “effect”, and “respect”. “the mother” is assigned three points, “effect” is assigned two points, and “respect” is assigned one point.

Next, the keyword obtainment unit 242 obtains similar keywords of the three keywords from the synonym DB 213. For example, similar keywords of “the mother” are “body of mother” and “body of maternity and after”, and similar keywords of “effect” are “operation” and “reaction” (see FIG. 7).

Next, the score calculation unit 243 determines whether a word equivalent to the characteristic keyword “the mother” or one of the similar keywords of “the mother” exists in the obtained opinion. A corresponding word exists in the opinion of student ID 12301. Therefore, the score calculation unit 243 sets three points assigned to the characteristic keyword “the mother” as the score of the consensus between the opinion of student ID 12301 and the agenda having agenda ID 00013.

Next, the score calculation unit 243 determines whether a word equivalent to the characteristic keyword “effect” or one of the similar keywords of “effect” exists in the obtained opinion. A corresponding word exists in the opinion of student ID 12301. Therefore, the score calculation unit 243 adds two points assigned to the characteristic keyword “effect” to the score of the consensus between the opinion of student ID 12301 and the agenda having agenda ID 00013, which makes the score five points.

Next, the score calculation unit 243 determines whether a word equivalent to the characteristic keyword “respect” or one of the similar keywords of “respect” exists in the obtained opinion. A corresponding word does not exist in the opinion of student ID 12301. Therefore, the score calculation unit 243 leaves the score unchanged at five.

Thus, the score is set to five for the consensus between the opinion of student ID 12301 and the agenda having agenda ID 00013.

As described above, a consensus is calculated by comparing a word included in an opinion of a student with a characteristic keyword relating to an agenda and synonyms of the characteristic keyword, or similar keywords. Therefore, an agenda having the content fit to an opinion of a student can be selected using the consensus.

Note that although a consensus is calculated using a characteristic keyword and its similar keywords in the present embodiment, it is not limited to that. A consensus may be calculated, for example, based on comparison between a word included in an opinion of a student and characteristic keywords.

The consensus calculation unit 234 executes the above consensus calculation process for all student IDs and associated opinions.

Next, grouping will be concretely described with reference to FIG. 8 that is executed by the grouping unit 235 according to the present embodiment.

The grouping unit 235 forms a group of student IDs that have the highest scores of the consensus for the same agenda.

For example, in the example in FIG. 8, the opinion of the student having student ID 12301 has the highest score of the consensus with agenda ID 00013. Therefore, the grouping unit 235 forms a group with group ID 000131 that includes students whose opinions have the highest scores of the consensus with agenda ID 00013.

Next, the grouping unit 235 refers to the opinion of the student having the student ID 12302 and its consensus with the agenda IDs. An agenda ID that has the highest score of the consensus with the opinion of the student having the student ID 12302 is agenda ID 00011. Therefore, the grouping unit 235 forms a group with group ID 000111 that includes students whose opinions have the highest scores of the consensus with agenda ID 00011.

Next, the grouping unit 235 refers to the opinion of the student having student ID 12303 and its consensus with the agenda IDs. The opinion of the student having student ID 12303 has the same score of the consensus, or zero, with all agenda IDs. Therefore, the grouping unit 235 reserves student ID 12303 for grouping.

Next, the grouping unit 235 refers to the opinion of the student having student ID 12304 and its consensus with the agenda IDs. An agenda ID that has the highest score of the consensus with the opinion of the student having student ID 12304 is agenda ID 00011. Therefore, the grouping unit 235 assigns group ID 000111 to the student having student ID 12304.

As described above, the grouping unit 235 assigns a group ID to each student ID. Note that the capacity of a group is set by the teacher terminal 200 in the present embodiment. Therefore, for example, if the number of members in the group ID 000131 reaches three, the grouping unit 235 assigns a new group ID for a student ID having the highest score of the consensus with agenda ID 00013. Also, the grouping unit 235 may assign the group ID of a group having the least number of members to a student ID that has been reserved for grouping.

In the example in FIG. 8, a group having the least number of members is a group having group ID 000131. Therefore, in the example in FIG. 8, group ID 000131 is assigned to student IDs 12303 and 12308 that have been reserved for grouping due to the same score of consensus for all agendas.

Alternatively, the grouping unit 235 may assign the group ID of a group having the number of members less than the capacity of a group, to a student ID that has been reserved for grouping.

In the example in FIG. 8, groups having the number of members less than the capacity of a group, which is three, are the group having group ID 000131 and the group having group ID 000121. Therefore, the grouping unit 235 may assign group IDs 000131 and 000121 to the grouping-reserved student IDs 12303 and 12308, respectively.

Next, operations of the teacher terminal 200 will be further described using examples of screens displayed on the teacher terminal 200 and the student terminal 300 according to the present embodiment.

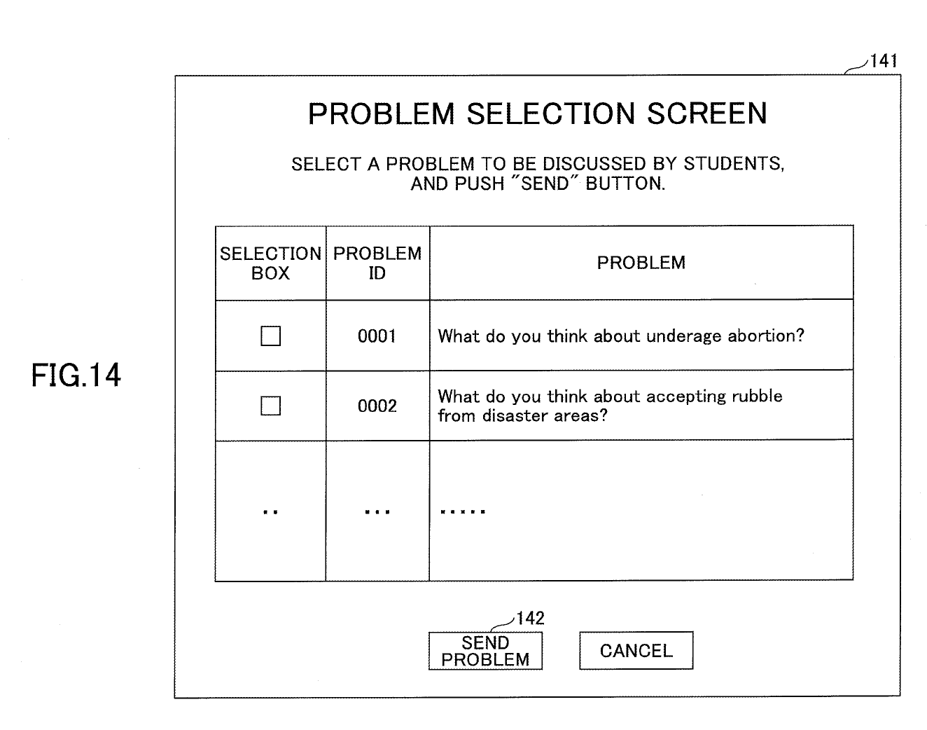

FIG. 14 is a schematic view illustrating an example of a problem selection screen displayed on the teacher terminal 200. In the problem selection screen 141 illustrated in FIG. 14, problem IDs and contents of problems are displayed with selection boxes. When a selection box associated with a problem ID is selected and a problem transmission button 142 is operated on the problem selection screen 141, the teacher terminal 200 transmits the problem having the problem ID associated with the selection box to the student terminals 300.

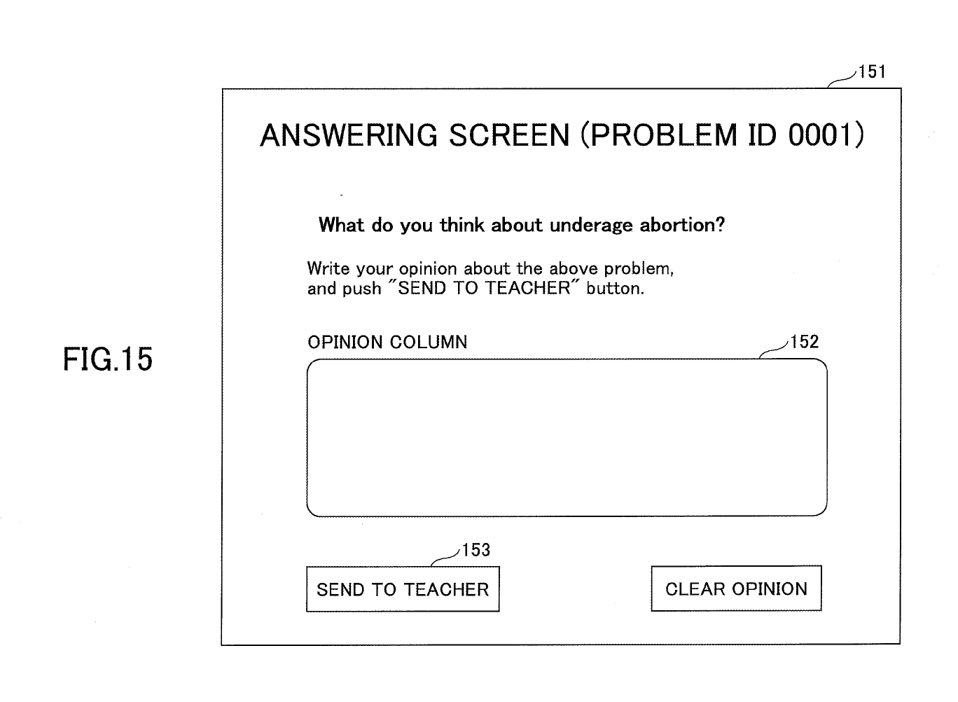

FIG. 15 is a schematic view illustrating an example of a problem screen displayed on the student terminal 300. When a problem is selected, the teacher terminal 200 generates problem screen data and transmits it to the student terminal 300 to have the student terminal 300 display it as a problem screen 151. In the problem screen 151, an opinion column 152, in which an opinion of a student is entered, and a transmission button 153 for transmitting the opinion to the teacher terminal 200 are displayed. In the problem screen 151, when an opinion of a student is entered and the transmission button for 153 is operated, the entered opinion is transmitted to the teacher terminal 200.

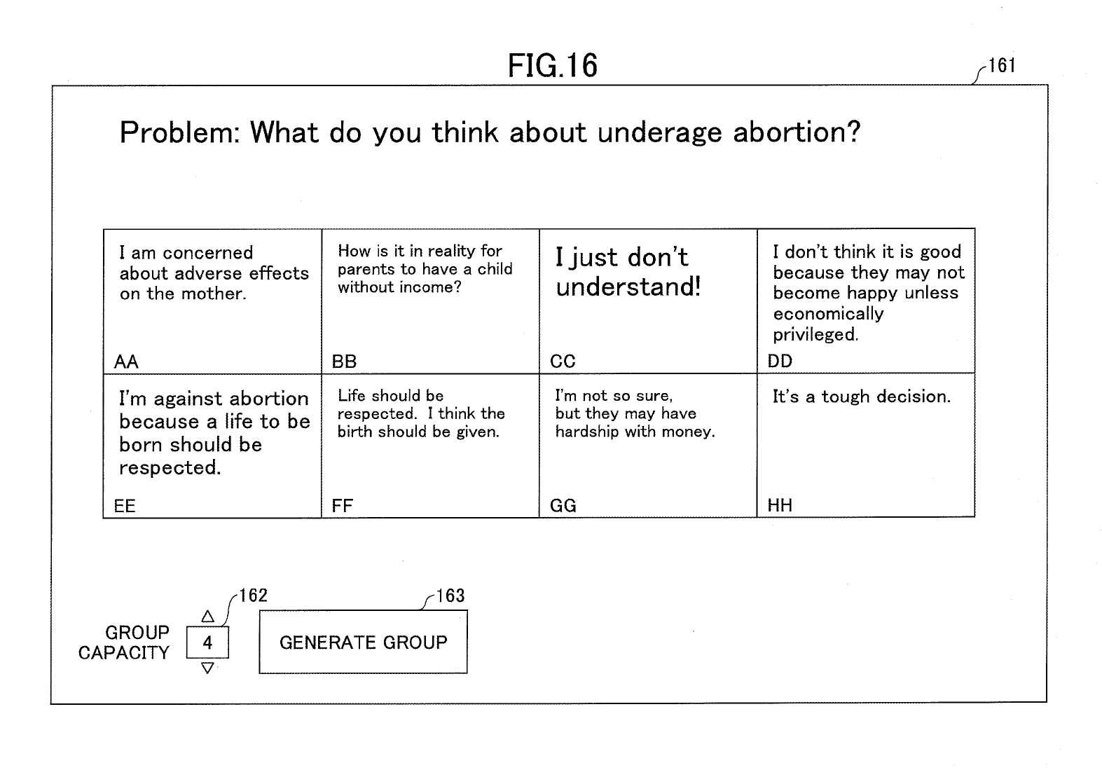

FIG. 16 is a schematic view illustrating an example of an opinion display screen 161 displayed on the teacher terminal 200. The teacher terminal 200 may have the display and operation unit 21 display the opinion display screen 161 illustrated in FIG. 16, for example, after having received opinions about the problem from all student terminals 300.

In the opinion display screen 161, opinions of students are displayed in a matrix format. In the opinion display screen 161, a group capacity input column 162 for entering the group capacity, and a group generation button 163 for giving a command to start grouping are also displayed.

For example, when the time limit for answering a problem has passed, and the group generation button 163 is operated, the teacher terminal 200 may have the consensus calculation unit 234 execute the consensus calculation process, to have the grouping unit 235 execute the grouping process.

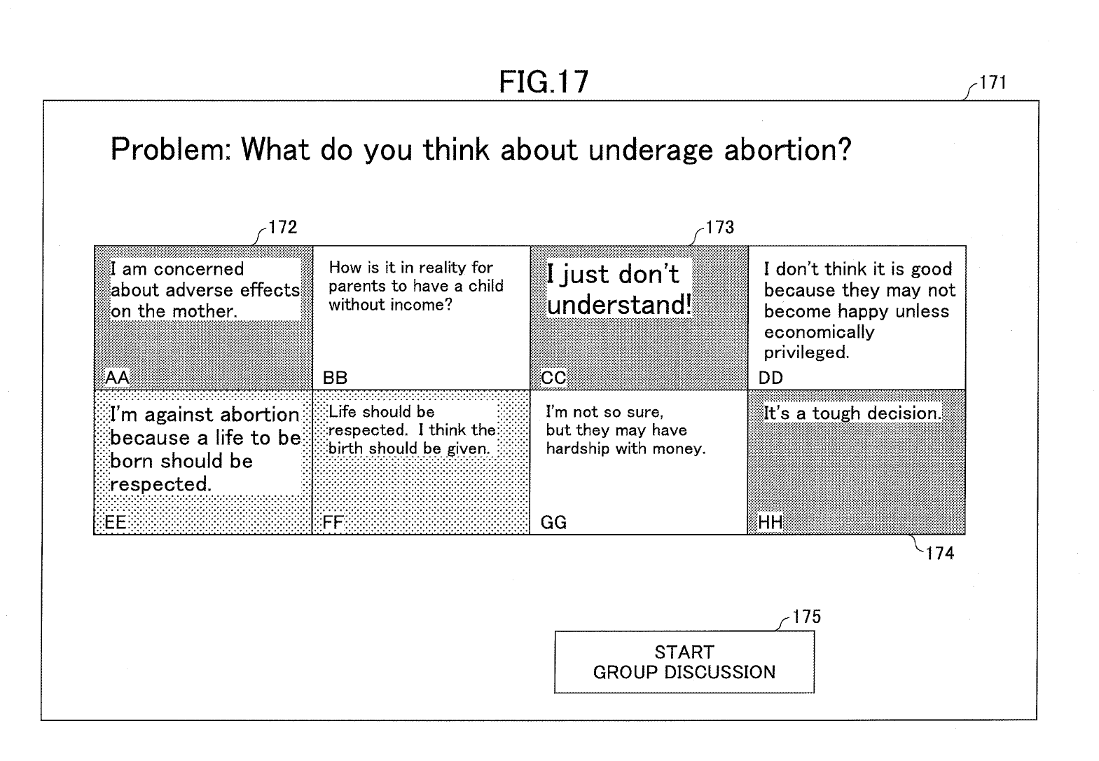

FIG. 17 is a first schematic view illustrating an example of an opinion display screen 171 displayed on the teacher terminal 200 after grouping. When the grouping process is completed by the grouping unit 235, the opinion display screen 171 illustrated in FIG. 17 is displayed at the teacher terminal 200. In the opinion display screen 171, for example, opinions of students are displayed so that the opinions of the students can be identified that are in the same group. Specifically, AA having student ID 12301, CC having student ID 12303, and HH having student ID 12308 are in the same group. Therefore, in the opinion display screen 171, the same color may be used for displaying areas 172, 173, and 174 where opinions of AA, CC, and HH are displayed, respectively. In the opinion display screen 171, a group discussion start button 175 is also displayed that is used for requesting to start discussions in the groups. When the group discussion start button 175 is operated, the teacher terminal 200 has discussions start in the groups.

Specifically, when the group discussion start button 175 is operated, the teacher terminal 200 has the discussion DB generation unit 236 generate a discussion DB 214 for each of the groups. Then, the teacher terminal 200 transmits DB IDs of the discussion DBs 214 of the respective groups to the student terminals 300 of the groups. The teacher terminal 200 further generates discussion screen data including an agenda associated with each of the groups, and transmits it to the corresponding student terminals 300.

In the following, generation of a discussion DB 214 will be described according to the present embodiment with reference to FIG. 9. The discussion DB generation unit 236 refers to the consensus work table 216 to obtain a group ID and an agenda ID having the highest score of the consensus among agenda IDs associated with the group ID. Then, the discussion DB generation unit 236 associates the problem ID with the obtained agenda ID and group ID. Further, the discussion DB generation unit 236 generates a DB ID and a storage area to store the content of the discussion, and associates them with the group ID.

The example in FIG. 9 illustrates the discussion DB 214 of group ID 000111. In the consensus work table 216, group ID 000111 is one of IDs generated for groups as a result of grouping of students using highest scores of consensus for agenda ID 00011. Therefore, the discussion DB generation unit 236 associates agenda ID 00011 with group ID 000111. Also, the discussion DB generation unit 236 assigns 1 as the DB ID, and associates the group ID with DB ID 1.

The storage area associated with DB ID 1 is used for storing the content of the discussion input on the student terminals 300 of the students having group ID 000111 assigned.

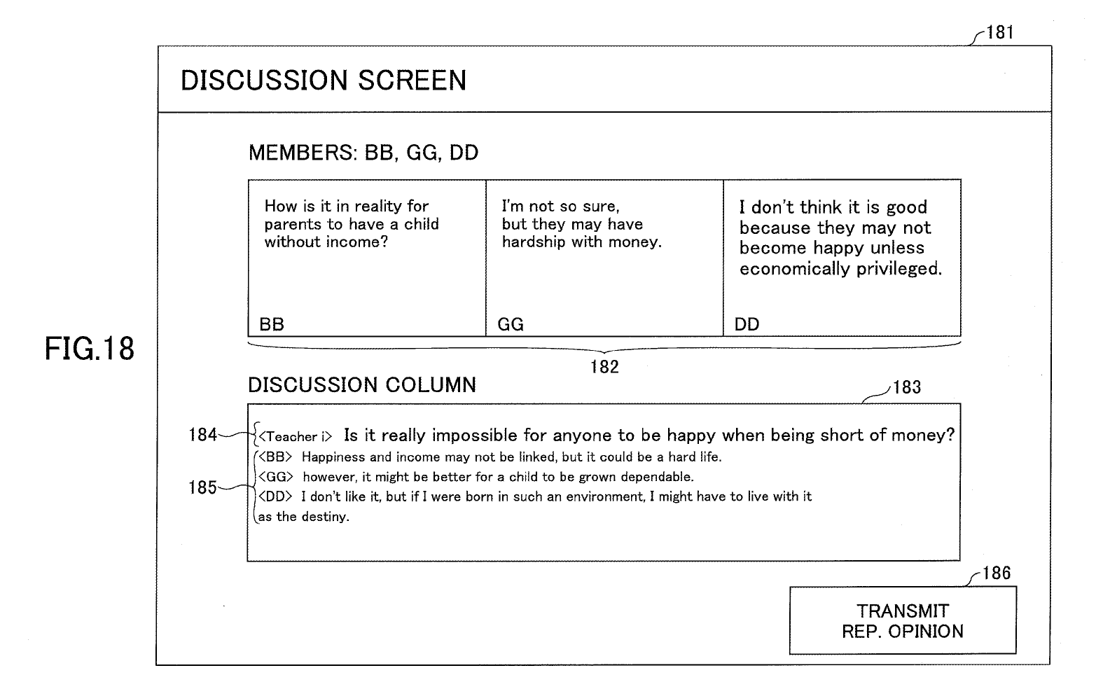

FIG. 18 is a schematic view illustrating a first example of a discussion screen 181 displayed on a student terminal 300. When receiving the discussion screen data and the DB ID of a discussion DB 214, the student terminal 300 displays the discussion screen 181 illustrated in FIG. 18.

The discussion screen 181 in FIG. 18 illustrates an example of the discussion screen of a group having group ID 000111. On the discussion screen 181, an area 182 for displaying the opinions of students in a group, and a discussion column 183 for entering the content of a discussion are displayed. In the discussion column 183, the agenda 184 and the content of the discussion 185 entered by the students of the group having the agenda 184 assigned are displayed. In addition, a representative opinion transmission button 186 is displayed on the discussion screen 181 that is used for making a transmission request to transmit the representative opinion of the group to the teacher terminal 200 as the result of the discussion.

FIG. 18 is an example of the discussion screen for group ID 000111. Students in group ID 000111 are BB having student ID 12302, DD having student ID 12304, and GG having student ID 12307.

Therefore, opinions of BB, DD and GG are displayed in the area 182. Also, the agenda 184 associated with group ID 000111 is displayed in the discussion column 183. The agenda ID of the agenda 184 is agenda ID 00011 that is associated with group ID 000111.

The discussion screen 181 is displayed on each of the student terminals 300 of the students in group ID 000111. Then, on the discussion screen 181 on each of the student terminals 300, an opinion of the student entered into the discussion column 183 is stored in the discussion DB 214 as content of the discussion. The content of the discussion stored in the discussion DB 214 is displayed in the discussion column 183 on each of the student terminals 300. Also, the teacher terminal 200 updates the content of the discussion displayed in the discussion column 183 on the discussion screen 181 on each of the student terminals 300 every time new content of the discussion is stored in the discussion DB 214.

As described above, students can make a group discussion without leaving their seats by viewing the content of the discussion entered at the student terminals 300 in the same group, displayed on the student terminals 300 according to the present embodiment.

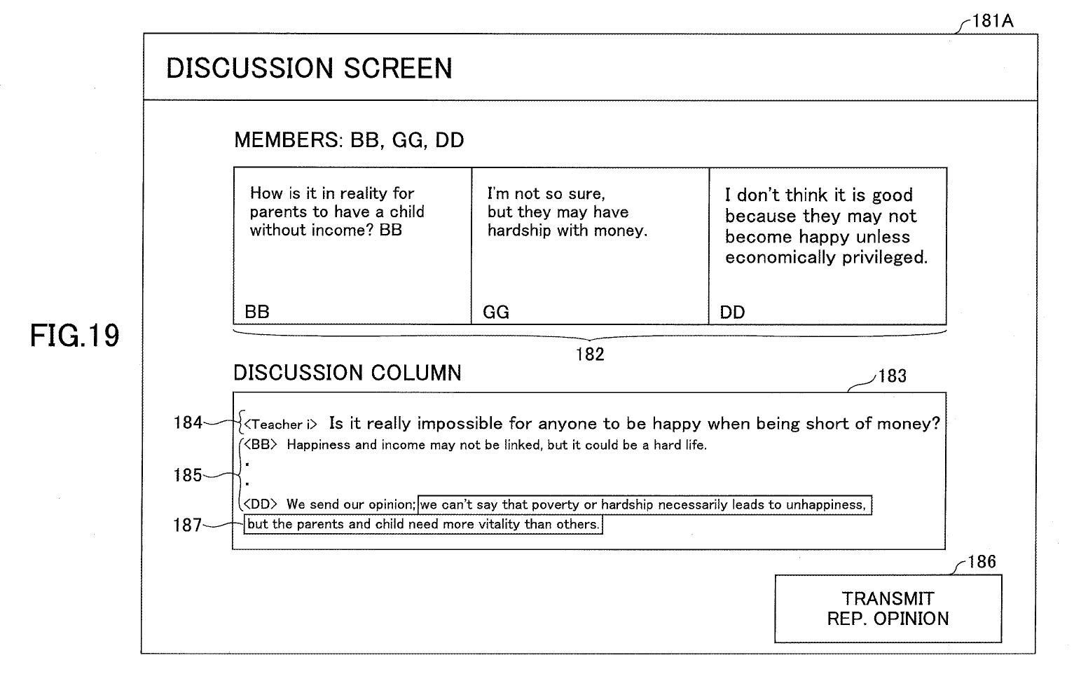

FIG. 19 is a schematic view illustrating a second example of a discussion screen 181A displayed on a student terminal 300. FIG. 19 illustrates an example where a representative opinion is selected in the content of the discussion displayed in the discussion column 183 in the discussion screen 181A.

In the discussion screen 181A illustrated in FIG. 19, a part of the text 187 is selected in the content of the discussion displayed in the discussion column 183 as the representative opinion of the group. When a part of the text 187 is selected in the discussion column 183 and the representative opinion the transmission button 186 is operated, the representative opinion of the group is transmitted from the student terminal 300 to the teacher terminal 200. Note that an arbitrary one of the student terminals 300 in the group may be used for transmitting the representative opinion. For example, a student may be determined as the leader in a group to transmit the representative opinion from the student terminal 300 of the leader.

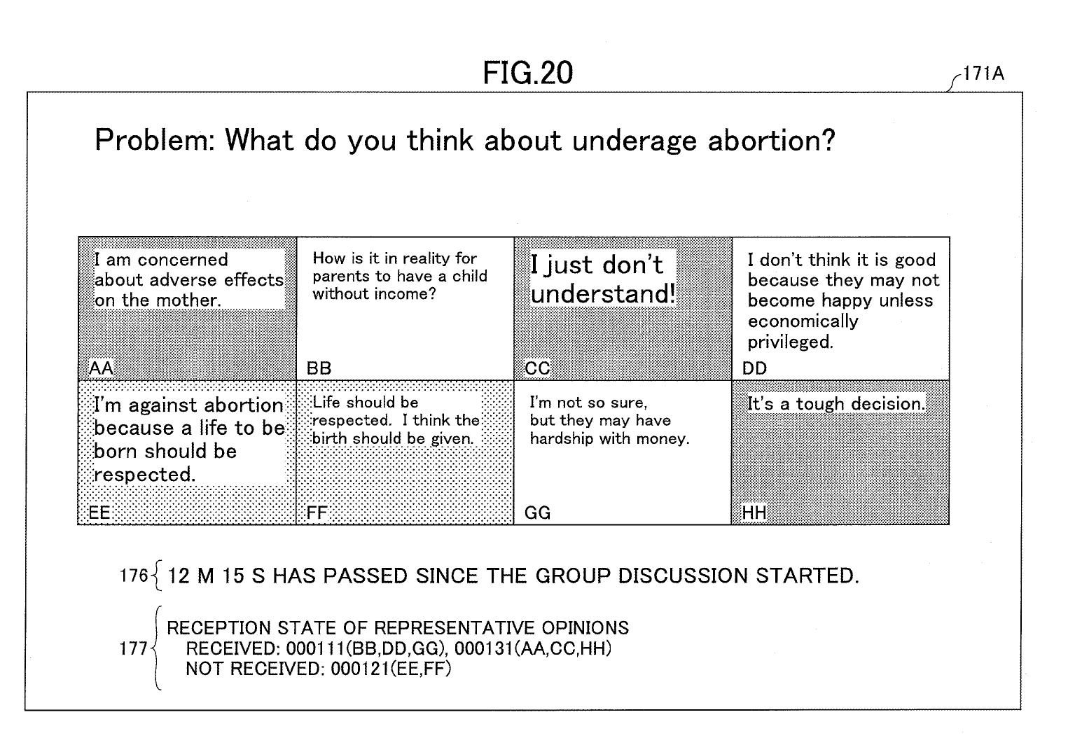

FIG. 20 is a second schematic view illustrating an example of an opinion display screen 171A displayed on the teacher terminal 300 after grouping. The opinion display screen 171 transitions into the opinion display screen 171A illustrated in FIG. 20 when the group discussion start button 175 is operated on the teacher terminal 200.

On the opinion display screen 171A, the group discussion start button 175 is not displayed, instead, time 176 that has passed since the start of the group discussion and a reception state 177 of the representative opinions from the groups is displayed.

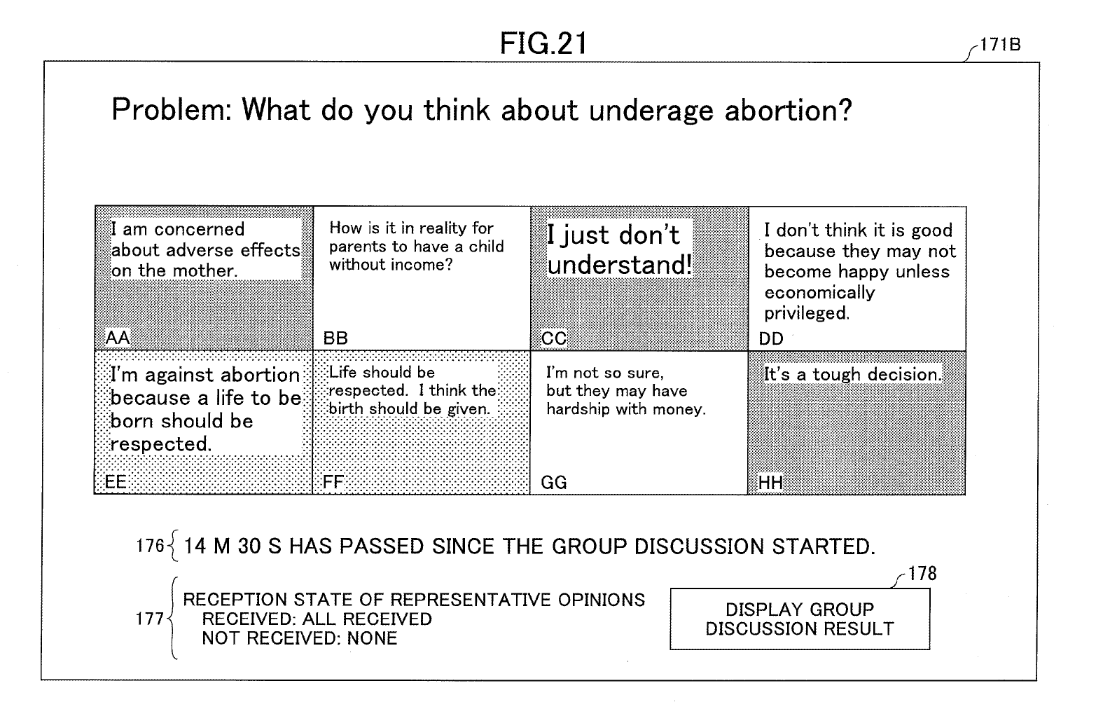

FIG. 21 is a third schematic view illustrating an example of an opinion display screen 171B displayed on the teacher terminal 200 after grouping. The opinion display screen 171A transitions into the opinion display screen 171B illustrated in FIG. 21 when the teacher terminal 200 receives the representative opinions from all groups.

On the opinion display screen 171B, time 176 that has passed since the start of the group discussion, a reception state 177 of the representative opinions from the groups are displayed, and a group discussion result display button 178 are displayed. The reception state 177 displayed on the opinion display screen 171B indicates that all representative opinions have been received. When the group discussion result display button 178 is operated on the opinion display screen 171B, the teacher terminal 200 displays the representative opinions of the groups.

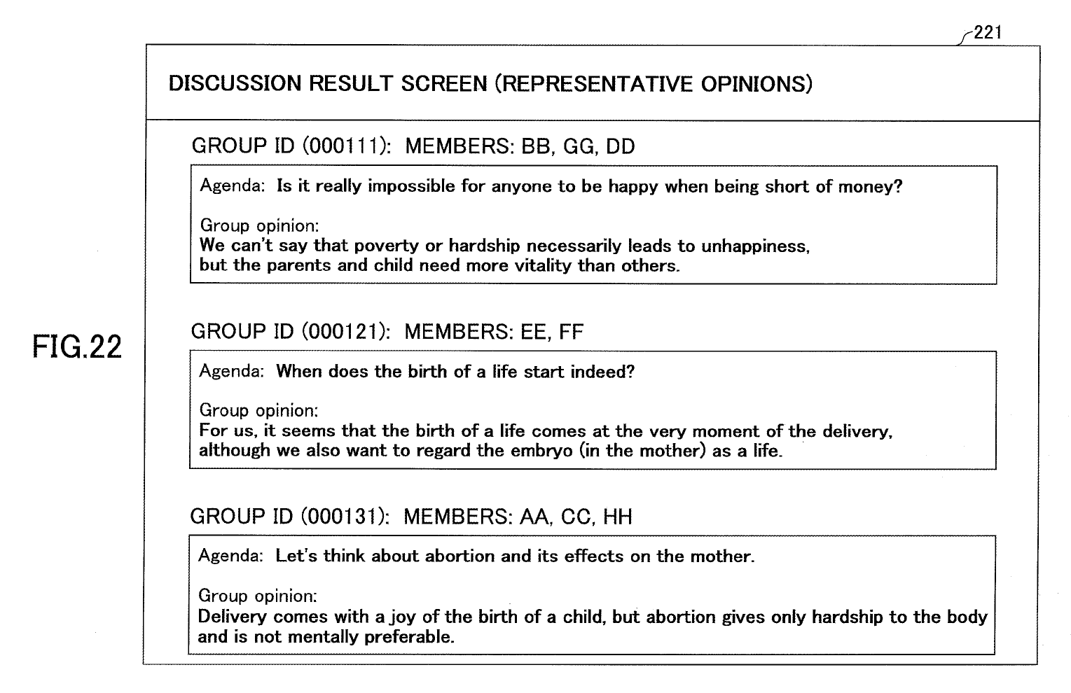

FIG. 22 is a schematic view illustrating an example of a discussion result display screen 221 displayed on the teacher terminal 200. The opinion display screen 171B transitions into the discussion result display screen 221 illustrated in FIG. 22 when the group discussion result display button 178 is operated on the teacher terminal 200.

On the discussion result display screen 221, the group ID of a group is associated with the members, agenda, and representative opinion of the group to be displayed.

As described above, according to the present embodiment, opinions of students about a common problem are gathered to form groups of students having opinions related to each other, and to have the students in each group discuss an agenda that has a meaning close to the opinions of the group. Namely, based on the score of consensus between the opinions of students and predetermined agendas, the teacher terminal 200 can execute grouping in accordance with the agendas, which makes it possible for students to have a deep discussion efficiently.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having a program stored therein for causing a computer to execute a discussion support method, the method comprising:
calculating a correlation between an opinion of a student and a plurality of agendas for each opinion of the student;
forming one or more groups of the students associated with one or more of the agendas, respectively, based on the correlations of the opinions and the agendas; and
transmitting the one or more of the agendas to terminals of the students in the respective groups associated with the respective agendas.

2. The computer-readable recording medium as claimed in claim 1, wherein the calculating obtains a plurality of characteristic keywords for each of the agendas, and calculates each of the correlations based on whether each of the opinions includes the characteristic keywords.

3. The computer-readable recording medium as claimed in claim 2, wherein each of the characteristic keywords has a value contributing to the correlation assigned, and the value contributing to the correlation is added to obtain the correlation if one of the characteristic keywords or a keyword similar to the characteristic keywords is included in the opinion.

4. The computer-readable recording medium as claimed in claim 1, the method further comprising:
generating a discussion DB for each of the groups to store content of a discussion input on a discussion screen displayed on each of the terminals,
wherein the transmitting has the content of the discussion stored in the discussion DB included in data to be transmitted to the terminals of the students.

5. The computer-readable recording medium as claimed in claim 1, wherein the forming forms the groups if receiving a command for the forming of the groups when the opinions of the students are received and displayed on a screen.

6. The computer-readable recording medium as claimed in claim 1, wherein the forming forms one of the groups if the calculated correlations between one of the students and the agendas satisfy a predetermined condition, and if the calculated correlations between one of the students and the agendas do not satisfy the predetermined condition, the one of the students is included in either one of the groups associated with one of the agendas.

7. The computer-readable recording medium as claimed in claim 5, wherein the forming forms the groups if receiving the command for the forming of the groups along with a maximum number of the students in one of the groups to form each of the groups not to exceed the maximum number of the students.

8. The computer-readable recording medium as claimed in claim 1, wherein the opinions of each of the students are related to a first problem and are input on the terminal of each of the students, and the agendas are related to the first problem.

9. A computer-readable recording medium having a program stored therein for causing a computer to execute a discussion support method, the method comprising:
calculating a correlation between an opinion of a student and an agenda for a plurality of the students and a plurality of the agendas;
forming one or more groups of the students associated with one or more of the agendas, respectively, based on the correlations of the opinions and the agendas; and
outputting information about the one or more groups of the students.

10. A computer-readable recording medium having a program stored therein for causing a computer to execute a discussion support method, the method comprising:
receiving an opinion of a student about a first problem on a terminal of the student, for a plurality of the students;
calculating a correlation between the opinion of the student and an agenda associated with the first problem for the plurality of students and a plurality of the agendas;
having each of the students be associated with one or more of the agendas based on the calculated correlations; and
transmitting the one or more of the agendas having been associated with the corresponding students to the terminal of each of the corresponding students.

11. A discussion support apparatus comprising:
a calculation unit configured to calculate a correlation between an opinion of a student and an agenda for a plurality of the students and a plurality of the agendas; and
a transmission unit configured to form one or more groups of the students associated with one or more of the agendas, respectively, based on the correlations of the opinions and the agendas, and to transmit the one or more of the agendas to terminals of the students in the respective groups associated with the respective agendas.

12. A discussion support method executed by a computer, the method comprising:
calculating a correlation between an opinion of a student and an agenda for a plurality of the students and a plurality of the agendas;
forming one or more groups of the students associated with one or more of the agendas, respectively, based on the correlations of the opinions and the agendas; and
transmitting the one or more of the agendas to terminals of the students in the respective groups associated with the respective agendas.
